(19) United States
(12) Patent Application Publication
(10) Pub. No.: US 2025/0337962 A1
(43) Pub. Date: Oct. 30, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Chaoyi LIN, Beijing (CN); Ye-Kui WANG, Los Angeles, CA (US); Yue LI, Los Angeles, CA (US); Kai ZHANG, Los Angeles, CA (US); Jizheng XU, Los Angeles, CA (US); Junru LI, Beijing (CN); Li ZHANG, Los Angeles, CA (US)

(21) Appl. No.: 19/261,679

(22) Filed: Jul. 7, 2025

Related U.S. Application Data
(63) Continuation of application No. PCT/CN2024/070935, filed on Jan. 5, 2024.

(30) Foreign Application Priority Data
Jan. 7, 2023 (WO) PCT/CN2023/071123

(51) Int. Cl. H04N 19/85; H04N 19/172; H04N 19/177; H04N 19/184; H04N 19/70

(52) U.S. Cl. CPC H04N 19/85; H04N 19/172; H04N 19/177; H04N 19/184; H04N 19/70

(57) ABSTRACT

Embodiments of the disclosure provide a solution for video processing. A method for video processing is proposed. The method includes: determining, for a conversion between a video unit of a video and a bitstream of the video, a neural-network post-filter (NNPF) is activated for a set of pictures; apply the NNPF to one or more pictures in the set of pictures according to an order; and performing the conversion based on the NNPF.

### CROSS REFERENCE

This application is a continuation of International Application No. PCT/CN2024/070935, filed on Jan. 5, 2024, which claims the benefits of International Application No. PCT/CN2023/071123, filed on Jan. 7, 2023. The entire contents of these applications are hereby incorporated by reference in their entireties.

### FIELDS

Embodiments of the present disclosure relates generally to video processing techniques, and more particularly, to a neural-network post-filter with multiple-picture input.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, a neural-network post-filter (NNPF) is activated for a set of pictures related to the video unit; apply the NNPF to one or more pictures in the set of pictures according to an order; and performing the conversion based on output of the NNPF. In this way, it specifies how to apply the NNPF and improves coding efficiency and performance.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a neural-network post-filter (NNPF) is activated for a set of pictures related to a video unit of the video; apply the NNPF to one or more pictures in the set of pictures according to an order; and generating the bitstream based on output of the NNPF.

In a fifth aspect, a method for storing a bitstream of a video is proposed. The method comprises: determining a neural-network post-filter (NNPF) is activated for a set of pictures related to a video unit of the video; apply the NNPF to one or more pictures in the set of pictures according to an order; generating the bitstream based on output of the NNPF; and storing the bitstream in a non-transitory computer-readable medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 is an illustration of deriving the four luma channels (right) from the luma component (left) when nnpfc_inp_order_idc is equal to 3;

FIG. 5 illustrates a flowchart of a method for video processing in accordance with embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

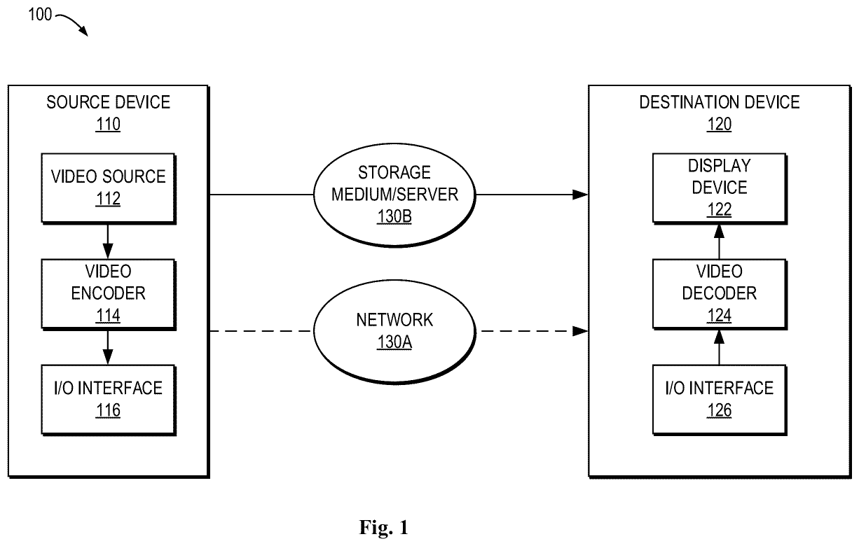

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

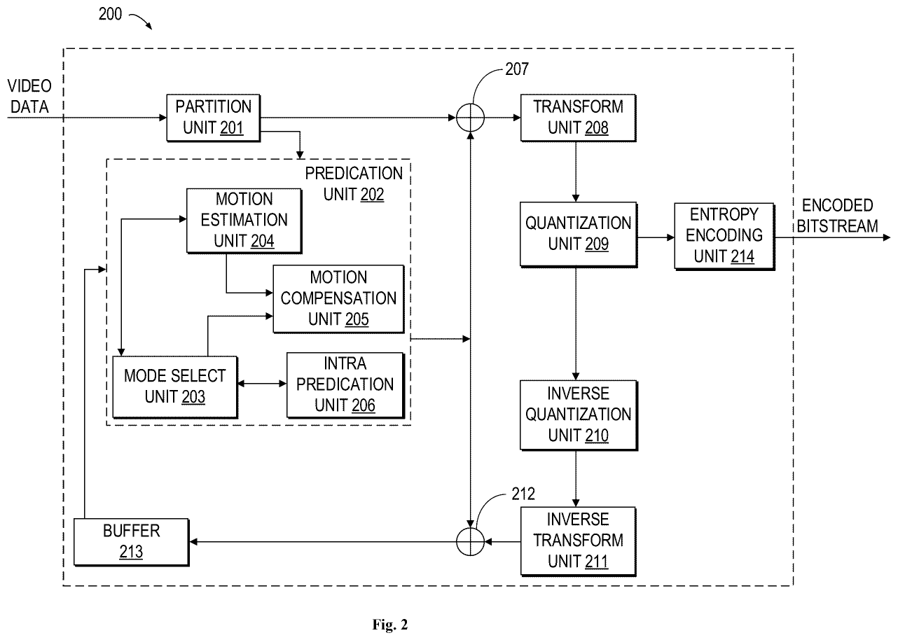

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block.

The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

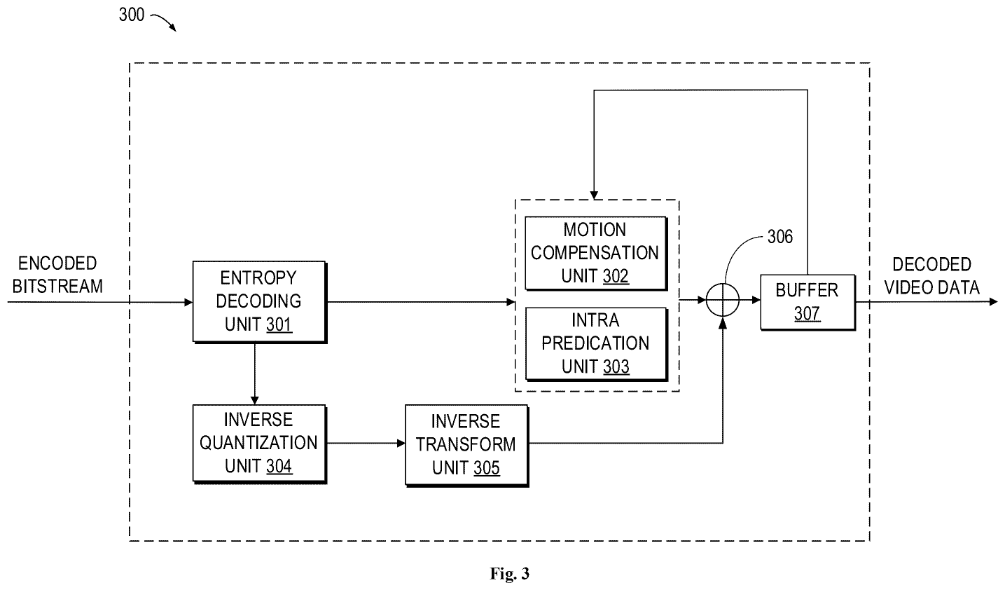

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

The present disclosure is related to image/video coding technologies. Specifically, it is related to the use of neural-network post filters with an input of multiple pictures. The ideas may be applied individually or in various combinations, for video bitstreams coded by any codec, e.g., the versatile video coding (VVC) standard and/or the versatile SEI messages for coded video bitstreams (VSEI) standard.

### 2. Abbreviations

APS Adaptation Parameter Set
AU Access Unit
CLVS Coded Layer Video Sequence
CLVSS Coded Layer Video Sequence Start
CRC Cyclic Redundancy Check
CVS Coded Video Sequence
FIR Finite Impulse Response
IRAP Intra Random Access Point
NAL Network Abstraction Layer
PPS Picture Parameter Set
PU Picture Unit
RASL Random Access Skipped Leading
SEI Supplemental Enhancement Information
STSA Step-wise Temporal Sublayer Access
VCL Video Coding Layer
VSEI versatile supplemental enhancement information (Rec. ITU-T H.274 | ISO/IEC 23002-7)
VUI Video Usability Information
VVC versatile video coding (Rec. ITU-T H.266 | ISO/IEC 23090-3)

### 3. Introduction

### 3.1 Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266 | ISO/IEC 23090-3) and the associated Versatile Supplemental Enhancement Information for coded video bitstreams (VSEI) standard (ITU-T H.274 | ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 3.2 SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274 | ISO/IEC 23002-7.

### 3.3 Signalling of Neural-Network Post-Filters

WG 05 output document N0158 and JVET-AB2006 include the specification of two SEI messages for signalling of neural-network post-filters, as follows.

### 8.28 Neural-Network Post-Filter Characteristics SEI Message

### 8.28.1 Neural-Network Post-Filter Characteristics SEI Message Syntax

| | Descriptor |
|---|---|
| nn_post_filter_characteristics( payloadSize ) { | |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_formatting_and_purpose_flag | u(1) |
| if( nnpfc_formatting_and_purpose_flag ) { | |
| nnpfc_purpose | ue(v) |
| /* input and output formatting */ | |
| if( nnpfc_purpose = = 2 \| \| nnpfc_purpose = = 4 ) | |
| nnpfc_out_sub_c_flag | u(1) |
| else if( nnpfc_purpose = = 3 \| \| nnpfc_purpose = = 4 ) { | |
| nnpfc_pic_width_in_luma_samples | ue(v) |
| nnpfc_pic_height_in_luma_samples | ue(v) |
| } | |
| else if( nnpfc_purpose = = 5 ) { | |
| nnpfc_num_input_pics_minus2 | ue(v) |
| for( i = 0; i <= nnpfc_num_input_pics_minus2; i++ ) | |
| nnpfc_interpolated_pics[ i ] | ue(v) |
| } | |
| nnpfc_component_last_flag | u(1) |
| nnpfc_inp_format_idc | ue(v) |
| if( nnpfc_inp_format_idc = = 1 ) | |
| nnpfc_inp_tensor_bitdepth_minus8 | ue(v) |
| nnpfc_inp_order_idc | ue(v) |
| nnpfc_auxiliary_inp_idc | ue(v) |
| nnpfc_separate_colour_description_present_flag | u(1) |
| if( nnpfc_separate_colour_description_present_flag ) { | |
| nnpfc_colour_primaries | u(8) |
| nnpfc_transfer_characteristics | u(8) |
| nnpfc_matrix_coeffs | u(8) |
| } | |
| nnpfc_out_format_idc | ue(v) |
| if( nnpfc_out_format_idc = = 1 ) | |
| nnpfc_out_tensor_bitdepth_minus8 | ue(v) |
| nnpfc_out_order_idc | ue(v) |
| nnpfc_constant_patch_size_flag | u(1) |
| nnpfc_patch_width_minus1 | ue(v) |
| nnpfc_patch_height_minus1 | ue(v) |
| nnpfc_overlap | ue(v) |
| nnpfc_padding_type | ue(v) |
| if( nnpfc_padding_type = = 4 ) { | |
| nnpfc_luma_padding_val | ue(v) |
| nnpfc_cb_padding_val | ue(v) |
| nnpfc_cr_padding_val | ue(v) |
| } | |
| nnpfc_complexity_info_present_flag | ue(v) |
| if( nnpfc_complexity_info_present_flag ) { | |
| nnpfc_parameter_type_idc | u(2) |
| if( nnpfc_parameter_type_idc != 2 ) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| } | |
| /* ISO/IEC 15938-17 bitstream */ | |
| if( nnpfc_mode_idc = = 0 ) { | |
| while( !byte_aligned( ) ) | |
| nnpfc_reserved_zero_bit_b | u(1) |
| for( i = 0; more_data_in_payload( ); i++ ) | |
| nnpfc_payload_byte[ i ] | b(8) |
| } | |

}

### 8.28.2 Neural-Network Post-Filter Characteristics SEI Message Semantics

The neural-network post-filter characteristics (NNPFC) SEI message specifies a neural network that may be used as a post-processing filter. The use of specified post-processing filters for specific pictures is indicated with neural-network post-filter activation SEI messages.

Use of this SEI message requires the definition of the following variables:
Cropped decoded output picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the cropped decoded output pictures with idx in the range of 0 to numInputPics−1, inclusive, that are used as input for the post-processing filter.
Bit depth BitDepth_{Y} for the luma sample array of the cropped decoded output pictures.
Bit depth BitDepth_{C} for the chroma sample arrays, if any, of the cropped decoded output pictures.
A chroma format indicator, denoted herein by ChromaFormatIdc, as described in subclause 7.3.
When nnpfc_auxiliary_inp_idc is equal to 1, a filtering strength control value StrengthControlVal that shall be a real number in the range of 0 to 1, inclusive.

The variables SubWidthC and SubHeightC are derived from ChromaFormatIdc as specified by Table 2.
NOTE 1—More than one NNPFC SEI message can be present for the same picture. When more than one NNPFC SEI message with different values of nnpfc_id is present or activated for the same picture, they can have the same or different values of nnpfc_purpose and nnpfc_mode_idc.

nnpfc_id contains an identifying number that may be used to identify a post-processing filter. The value of nnpfc_id shall be in the range of 0 to 2³²−2, inclusive. Values of nnpfc_id from 256 to 511, inclusive, and from 2³¹ to 2³²−2, inclusive, are reserved for future use by ITU-T | ISO/IEC. Decoders conforming to this edition of this document encountering an NNPFC SEI message with nnpfc_id in the range of 256 to 511, inclusive, or in the range of 2³¹ to 2³²−2, inclusive, shall ignore the SEI message.

When an NNPFC SEI message is the first NNPFC SEI message, in decoding order, that has a particular nnpfc_id value within the current CLVS, the following applies:
This SEI message specifies a base post-processing filter.
This SEI message pertains to the current decoded picture and all subsequent decoded pictures of the current layer, in output order, until the end of the current CLVS.

When an NNPFC SEI message is a repetition of a previous NNPFC SEI message, in decoding order, in the current CLVS, the subsequent semantics apply as if this SEI message were the only NNPFC SEI message having the same content within the current CLVS.

When an NNPFC SEI message is not the first NNPFC SEI message, in decoding order, that has a particular nnpfc_id value within the current CLVS, the following applies:
This SEI message defines an update relative to the preceding base post-processing filter in decoding order with the same nnpfc_id value.
This SEI message pertains to the current decoded picture and all subsequent decoded pictures of the current layer, in output order, until the end of the current CLVS or the next NNPFC SEI message having that particular nnpfc_id value, in output order, within the current CLVS.

nnpfc_mode_idc equal to 0 indicates that this SEI message contains an ISO/IEC 15938-17 bitstream that specifies a base post-processing filter or is an update relative to the base post-processing filter with the same nnpfc_id value.

When an NNPFC SEI message is the first NNPFC SEI message, in decoding order, that has a particular nnpfc_id value within the current CLVS, nnpfc_mode_idc equal to 1 specifies that the base post-processing filter associated with the nnpfc_id value is a neural network identified by the URI indicated by nnpfc_uri with the format identified by the tag URI nnpfc_tag_uri.

When an NNPFC SEI message is not the first NNPFC SEI message, in decoding order, that has a particular nnpfc_id value within the current CLVS, nnpfc_mode_idc equal to 1 specifies that an update relative to the base post-processing filter with the same nnpfc_id value is defined by the URI indicated by nnpfc_uri with the format identified by the tag URI nnpfc_tag_uri.

The value of nnpfc_mode_idc shall be in the range of 0 to 1, inclusive, in bitstreams conforming to this edition of this document. Values of 2 to 255, inclusive, for nnpfc_mode_idc are reserved for future use by ITU-T | ISO/IEC and shall not be present in bitstreams conforming to this edition of this document. Decoders conforming to this edition of this document shall ignore NNPFC SEI messages with nnpfc_mode_idc in the range of 2 to 255, inclusive. Values of nnpfc_mode_idc greater than 255 shall not be present in bitstreams conforming to this edition of this document and are not reserved for future use.

When this SEI message is the first NNPFC SEI message, in decoding order, that has a particular nnpfc_id value within the current CLVS, the post-processing filter PostProcessingFilter( ) is assigned to be the same as the base post-processing filter.

When this SEI message is not the first NNPFC SEI message, in decoding order, that has a particular nnpfc_id value within the current CLVS, a post-processing filter PostProcessingFilter( ) is obtained by applying the update defined by this SEI message to the base post-processing filter.

Updates are not cumulative but rather each update is applied on the base post-processing filter, which is the post-processing filter specified by the first NNPFC SEI message, in decoding order, that has a particular nnpfc_id value within the current CLVS.

nnpfc_reserved_zero_bit_a shall be equal to 0 in bitstreams conforming to this edition of this document. Decoders shall ignore NNPFC SEI messages in which nnpfc_reserved_zero_bit_a is not equal to 0.

nnpfc_tag_uri contains a tag URI with syntax and semantics as specified in IETF RFC 4151 identifying the format and associated information about the neural network used as a base post-processing filter or an update relative to the base post-processing filter with the same nnpfc_id value specified by nnpfc_uri.
NOTE 2-nnpfc_tag_uri enables uniquely identifying the format of neural network data specified by nnrpf_uri without needing a central registration authority.

nnpfc_tag_uri equal to “tag: iso.org,2023:15938-17” indicates that the neural network data identified by nnpfc_uri conforms to ISO/IEC 15938-17.

nnpfc_uri contains a URI with syntax and semantics as specified in IETF Internet Standard 66 identifying the neural network used as a base post-processing filter or an update relative to the base post-processing filter with the same nnpfc_id value.

nnpfc_formatting_and_purpose_flag equal to 1 specifies that syntax elements related to the filter purpose, input formatting, output formatting, and complexity are present. nnpfc_formatting_and_purpose_flag equal to 0 specifies that no syntax elements related to the filter purpose, input formatting, output formatting, and complexity are present.

When this SEI message is the first NNPFC SEI message, in decoding order, that has a particular nnpfc_id value within the current CLVS, nnpfc_formatting_and_purpose_flag shall be equal to 1. When this SEI message is not the first NNPFC SEI message, in decoding order, that has a particular nnpfc_id value within the current CLVS, nnpfc_formatting_and_purpose_flag shall be equal to 0.

nnpfc_purpose indicates the purpose of the post-processing filter as specified in Table 2-1.

The value of nnpfc_purpose shall be in the range of 0 to 5, inclusive, in bitstreams conforming to this edition of this document. Values of 6 to 1023, inclusive, for nnpfc_purpose are reserved for future use by ITU-T | ISO/IEC and shall not be present in bitstreams conforming to this edition of this document. Decoders conforming to this edition of this document shall ignore NNPFC SEI messages with nnpfc_purpose in the range of 6 to 1203, inclusive. Values of nnpfc_purpose greater than 1023 shall not be present in bitstreams conforming to this edition of this document and are not reserved for future use.

TABLE 2-1
Definition of nnpfc_purpose

| Value | Interpretation |
|---|---|
| 0 | May be used as determined by the application |
| 1 | Visual quality improvement |
| 2 | Chroma upsampling from the 4:2:0 chroma format |
| | to the 4:2:2 or 4:4:4 chroma format, or from |
| | the 4:2:2 chroma format to the 4:4:4 chroma format |
| 3 | Increasing the width or height of the cropped decoded |
| | output picture without changing the chroma format |
| 4 | Increasing the width or height of the cropped decoded |
| | output picture and upsampling the chroma format |
| 5 | Picture rate upsampling |

NOTE 3-When a reserved value of nnpfc_purpose is taken into use in the future by ITU-T | ISO/IEC, the syntax of this SEI message could be extended with syntax elements whose presence is conditioned by nnpfc_purpose being equal to that value.

When SubWidthC is equal to 1 and SubHeightC is equal to 1, nnpfc_purpose shall not be equal to 2 or 4. nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1.

When nnpfc_out_sub_c_flag is not present, outSubWidthC is inferred to be equal to SubWidthC and outSubHeightC is inferred to be equal to SubHeightC. When ChromaFormatIdc is equal to 2 and nnpfc_out_sub_c_flag is present, the value of nnpfc_out_sub_c_flag shall be equal to 1. nnpfc_pic_width_in_luma_samples and nnpfc_pic_height_in_luma_samples specify the width and height, respectively, of the luma sample array of the picture resulting from applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16−1, inclusive. The value of nnpfc_pic_height_in_luma_samples shall be in the range of CroppedHeight to CroppedHeight*16−1, inclusive.

nnpfc_num_input_pics_minus2 plus 2 specifies the number of decoded output pictures used as input for the post-processing filter.

nnpfc_interpolated_pics[i] specifies the number of interpolated pictures generated by the post-processing filter between the i-th and the (i+1)-th picture used as input for the post-processing filter.

The variables numInputPics, specifying the number of pictures used as input for the post-processing filter, and numOutputPics, specifying the total number of pictures resulting from the post-processing filter, are derived as follows:

if( nnpfc_purpose = = 5 ) {
numInputPics = nnpfc_num_input_pics_minus2 + 2

| | |
|---|---|
| for( i = 0, numOutputPics = 0; i <= numInputPics − 2; i++ ) | (76) |

```
    numOutputPics += nnpfc_interpolated_pics[ i ]
} else
  numInputPics = 1.
```

nnpfc_component_last_flag equal to 1 indicates that the last dimension in the input tensor inputTensor to the post-processing filter and the output tensor outputTensor resulting from the post-processing filter is used for a current channel. nnpfc_component_last_flag equal to 0 indicates that the third dimension in the input tensor inputTensor to the post-processing filter and the output tensor outputTensor resulting from the post-processing filter is used for a current channel.
NOTE 4—The first dimension in the input tensor and in the output tensor is used for the batch index, which is a practice in some neural network frameworks. While formulae in the semantics of this SEI message use the batch size corresponding to the batch index equal to 0, it is up to the post-processing implementation to determine the batch size used as input to the neural network inference.
NOTE 5—For example, when nnpfc_inp_order_idc is equal to 3 and nnpfc_auxiliary_inp_idc is equal to 1, there are 7 channels in the input tensor, including four luma matrices, two chroma matrices, and one auxiliary input matrix. In this case, the process DeriveInputTensors( ) would derive each of these 7 channels of the input tensor one by one, and when a particular channel of these channels is processed, that channel is referred to as the current channel during the process.

nnpfc_inp_format_idc indicates the method of converting a sample value of the cropped decoded output picture to an input value to the post-processing filter. When nnpfc_inp_format_idc is equal to 0, the input values to the post-processing filter are real numbers and the functions InpY( ) and InpC( ) are specified as follows:

| | |
|---|---|
| InpY( x ) = x ÷ ( ( 1 << BitDepthY ) − 1 ) | (77) |
| InpC( x )= x ÷ ( ( 1 << BitDepthC ) − 1 ) | (78) |

When nnpfc_inp_format_idc is equal to 1, the input values to the post-processing filter are unsigned integer numbers and the functions InpY( ) and InpC( ) are specified as follows:

| | |
|---|---|
| shiftY = BitDepth_{Y} − inpTensorBitDepth | |
| if( inpTensorBitDepth >= BitDepth_{Y}) | |
| InpY( x ) = x << ( inpTensorBitDepth − BitDepth_{Y} ) | (79) |
| else | |
| InpY( x ) = Clip3(0, ( 1 << inpTensorBitDepth ) − 1, ( x + ( 1 << (shiftY − | |
| 1 ) ) ) >> shiftY ) | |
| shiftC = BitDepth_{C} − inpTensorBitDepth | |
| if( inpTensorBitDepth >= BitDepth_{C} ) | |
| InpC( x ) = x << (inpTensorBitDepth − BitDepth_{C} ) | (80) |
| else | |
| InpC( x ) = Clip3(0, ( 1 << inpTensorBitDepth ) − 1, ( x + ( 1 << ( shiftC − | |
| 1 ) ) ) >> shiftC ). | |

The variable inpTensorBitDepth is derived from the syntax element nnpfc_inp_tensor_bitdepth_minus8 as specified below.

Values of nnpfc_inp_format_idc greater than 1 are reserved for future specification by ITU-T | ISO/IEC and shall not be present in bitstreams conforming to this edition of this document. Decoders conforming to this edition of this document shall ignore NNPFC SEI messages that contain reserved values of nnpfc_inp_format_idc. nnpfc_inp_tensor_bitdepth_minus8 plus 8 specifies the bit depth of luma sample values in the input integer tensor. The value of inpTensorBitDepth is derived as follows:

$$inpTensorBitDepth = nnpfc\_inp \_tensor \_bitdepth \_minus8 + 8. \qquad ( 81 )$$

It is a requirement of bitstream conformance that the value of nnpfc_inp_tensor_bitdepth_minus8 shall be in the range of 0 to 24, inclusive.

nnpfc_inp_order_idc indicates the method of ordering the sample arrays of a cropped decoded output picture as one of the input pictures to the post-processing filter.

The value of nnpfc_inp_order_idc shall be in the range of 0 to 3, inclusive, in bitstreams conforming to this edition of this document. Values of 4 to 255, inclusive, for nnpfc_inp_order_idc are reserved for future use by ITU-T | ISO/IEC and shall not be present in bitstreams conforming to this edition of this document. Decoders conforming to this edition of this document shall ignore NNPFC SEI messages with nnpfc_inp_order_idc in the range of 4 to 255, inclusive. Values of nnpfc_inp_order_idc greater than 255 shall not be present in bitstreams conforming to this edition of this document and are not reserved for future use.

When ChromaFormatIdc is not equal to 1, nnpfc_inp_order_idc shall not be equal to 3.

Table 2-2 contains an informative description of nnpfc_inp_order_idc values.

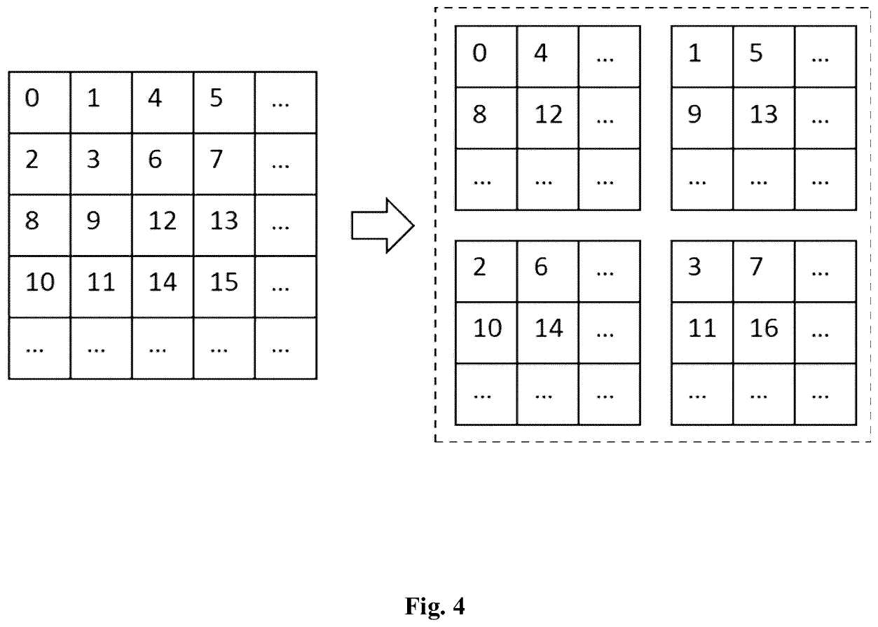

TABLE 2-2
Description of nnpfc_inp_order_idc values

| nnpfc_inp_{—} | |
|---|---|
| order_idc | Description |
| 0 | If nnpfc_auxiliary_inp_idc is equal to 0, one luma matrix is present in the input tensor for |
| | each input picture, and the number of channels is 1. Otherwise when |
| | nnpfc_auxiliary_inp_idc is equal to 1, one luma matrix and one auxiliary input matrix are |
| | present, and the number of channels is 2. |
| 1 | If nnpfc_auxiliary_inp_idc is equal to 0, two chroma matrices are present in the input |
| | tensor, and the number of channels is 2. Otherwise when nnpfc_auxiliary_inp_idc is equal |
| | to 1, two chroma matrices and one auxiliary input matrix are present, and the number of |
| | channels is 3. |
| 2 | If nnpfc_auxiliary_inp_idc is equal to 0, one luma and two chroma matrices are present in |
| | the input tensor, and the number of channels is 3. Otherwise when nnpfc_auxiliary_inp_idc |
| | is equal to 1, one luma matrix, two chroma matrices and one auxiliary input matrix are |
| | present, and the number of channels is 4. |
| 3 | If nnpfc_auxiliary_inp_idc is equal to 0, four luma matrices and two chroma matrices are |
| | present in the input tensor, and the number of channels is 6. Otherwise when |
| | nnpfc_auxiliary_inp_idc is equal to 1, four luma matrices, two chroma matrices, and one |
| | auxiliary input matrix are present in the input tensor, and the number of channels is 7. The |
| | luma channels are derived in an interleaved manner as illustrated in FIG. 4. This |
| | nnpfc_inp_order_idc can only be used when the chroma format is 4:2:0. FIG. 4 is an |
| | illustration of deriving the four luma channles (right) from the luma component (left) when |
| | nnpfc_inp_order_idc is equal to 3. |
| 4 . . . 255 | Reserved |

A patch is a rectangular array of samples from a component (e.g., a luma or chroma component) of a picture. nnpfc_auxiliary_inp_idc greater than 0 indicates that auxiliary input data is present in the input tensor of the neural-network post-filter. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 82.

The value of nnpfc_auxiliary_inp_idc shall be in the range of 0 to 1, inclusive, in bitstreams conforming to this edition of this document. Values of 2 to 255, inclusive, for nnpfc_inp_order_idc are reserved for future use by ITU-T | ISO/IEC and shall not be present in bitstreams conforming to this edition of this document. Decoders conforming to this edition of this document shall ignore NNPFC SEI messages with nnpfc_inp_order_idc in the range of 2 to 255, inclusive. Values of nnpfc_inp_order_idc greater than 255 shall not be present in bitstreams conforming to this edition of this document and are not reserved for future use.

The process DeriveInputTensors( ) for deriving the input tensor inputTensor for a given vertical sample coordinate cTop and a horizontal sample coordinate cLeft specifying the top-left sample location for the patch of samples included in the input tensor, is specified as follows:

```
for( i = 0; i < numInputPics; i++ ) {
  if( nnpfc_inp_order_idc = = 0 )
    for( yP = −overlapSize; yP < inpPatchHeight + overlapSize; yP++)
      for( xP = −overlapSize; xP < inpPatchWidth + overlapSize; xP++ ) {
        inpVal = InpY( InpSampleVal( cTop + yP, cLeft + xP, CroppedHeight,
            CroppedWidth, CroppedYPic[ i ] ) )
        if( !nnpfc_component_last_flag )
          inputTensor[ 0 ][ i ][ 0 ][ yP + overlapSize ][ xP + overlapSize ] = inpVal
        else
          inputTensor[ 0 ][ i ][ yP + overlapSize ][ xP + overlapSize ][ 0 ] = inpVal
        if( nnpfc_auxiliary_inp_idc = = 1 )
          if( !nnpfc_component_last_flag )
            inputTensor[ 0 ][ i ][ 1 ][ yP + overlapSize ][ xP + overlapSize ] = StrengthControlVal
          else
            inputTensor[ 0 ][ i ][ yP + overlapSize ][ xP + overlapSize ][ 1 ] = StrengthControlVal
      }
```

| | |
|---|---|
| else if( nnpfc_inp_order_idc = = 1 ) | (82) |

```
    for( yP = −overlapSize; yP < inpPatchHeight + overlapSize; yP++)
      for( xP = −overlapSize; xP < inpPatchWidth + overlapSize; xP++ ) {
        inpCbVal = InpC( InpSampleVal( cTop + yP, cLeft + xP, CroppedHeight / SubHeightC,
            CroppedWidth / SubWidthC, CroppedCbPic[ i ] ) )
        inpCrVal = InpC( InpSampleVal( cTop + yP, cLeft + xP, CroppedHeight / SubHeightC,
            CroppedWidth / SubWidthC, CroppedCrPic[ i ] ) )
        if( !nnpfc_component_last_flag ) {
          inputTensor[ 0 ][ i ][ 0 ][ yP + overlapSize ][ xP + overlapSize ] = inpCbVal
          inputTensor[ 0 ][ i ][ 1 ][ yP + overlapSize ][ xP + overlapSize ] = inpCrVal
        } else {
          inputTensor[ 0 ][ i ][ yP + overlapSize ][ xP + overlapSize ][ 0 ] = inpCbVal
          inputTensor[ 0 ][ i ][ yP + overlapSize ][ xP + overlapSize ][ 1 ] = inpCrVal
        }
        if( nnpfc_auxiliary_inp_idc = = 1 )
          if( !nnpfc_component_last_flag )
            inputTensor[ 0 ][ i ][ 2 ][ yP + overlapSize ][ xP + overlapSize ] = StrengthControlVal
          else
            inputTensor[ 0 ][ i ][ yP + overlapSize ][ xP + overlapSize ][ 2 ] = StrengthControlVal
      }
  else if( nnpfc_inp_order_idc = = 2 )
    for( yP = −overlapSize; yP < inpPatchHeight + overlapSize; yP++)
      for( xP = −overlapSize; xP < inpPatchWidth + overlapSize; xP++ ) {
        yY = cTop + yP
        xY = cLeft + xP
        yC = yY / SubHeightC
        xC = xY / SubWidthC
        inpYVal = InpY( InpSample Val( yY, xY, CroppedHeight,
            CroppedWidth, CroppedYPic[ i ] ) )
        inpCbVal = InpC( InpSampleVal( yC, xC, CroppedHeight / SubHeightC,
            CroppedWidth / SubWidthC, CroppedCbPic[ i] ) )
        inpCrVal = InpC( InpSampleVal( yC, xC, CroppedHeight / SubHeightC,
            CroppedWidth / SubWidthC, CroppedCrPic[ i ] ) )
        if( !nnpfc_component_last_flag ) {
          inputTensor[ 0 ][ i ][ 0 ][ yP + overlapSize ][ xP + overlapSize ] = inpYVal
          inputTensor[ 0 ][ i ][ 1 ][ yP + overlapSize ][ xP + overlapSize ] = inpCbVal
          inputTensor[ 0 ][ i ][ 2 ][ yP + overlapSize ][ xP + overlapSize ] = inpCrVal
        } else {
          inputTensor[ 0 ][ i ][ yP + overlapSize ][ xP + overlapSize ][ 0 ] = inpYVal
          inputTensor[ 0 ][ i ][ yP + overlapSize ][ xP + overlapSize ][ 1 ] = inpCbVal
          inputTensor[ 0 ][ i ][ yP + overlapSize ][ xP + overlapSize ][ 2 ] = inpCrVal
        }
        if( nnpfc_auxiliary_inp_idc = = 1 )
          if( !nnpfc_component_last_flag )
            inputTensor[ 0 ][ i ][ 3 ][ yP + overlapSize ][ xP + overlapSize ] = StrengthControlVal
          else
            inputTensor[ 0 ][ i ][ yP + overlapSize ][ xP + overlapSize ][ 3 ] = StrengthControlVal
      }
  else if( nnpfc_inp_order_idc = = 3 )
    for( yP = −overlapSize; yP < inpPatchHeight + overlapSize; yP++)
      for( xP = −overlapSize; xP < inpPatchWidth + overlapSize; xP++ ) {
        yTL = cTop + yP * 2
        xTL = cLeft + xP * 2
        yBR = yTL + 1
        xBR = xTL + 1
        yC = cTop / 2 + yP
        xC = cLeft / 2 + xP
        inpTLVal = InpY( InpSampleVal( yTL, xTL, CroppedHeight,
            CroppedWidth, CroppedYPic[ i ] ) )
        inpTRVal = InpY( InpSample Val( yTL, xBR, CroppedHeight,
            CroppedWidth, CroppedYPic[ i ] ) )
        inpBLVal = InpY( InpSampleVal( yBR, xTL, CroppedHeight,
            CroppedWidth, CroppedYPic[ i ] ) )
        inpBRVal = InpY( InpSampleVal( yBR, xBR, CroppedHeight,
            CroppedWidth, CroppedYPic[ i ] ) )
        inpCbVal = InpC( InpSampleVal( yC, xC, CroppedHeight / 2,
            CroppedWidth / 2, CroppedCbPic[ i ] ) )
        inpCrVal = InpC( InpSampleVal( yC, xC, CroppedHeight / 2,
            CroppedWidth / 2, CroppedCrPic[ i ] ) )
        if( !nnpfc_component_last_flag ) {
          inputTensor[ 0 ][ i ][ 0 ][ yP + overlapSize ][ xP + overlapSize ] = inpTLVal
          inputTensor[ 0 ][ i ][ 1 ][ yP + overlapSize ][ xP + overlapSize ] = inpTRVal
          inputTensor[ 0 ][ i ][ 2 ][ yP + overlapSize ][ xP + overlapSize ] = inpBLVal
          inputTensor[ 0 ][ i ][ 3 ][ yP + overlapSize ][ xP + overlapSize ] = inpBRVal
          inputTensor[ 0 ][ i ][ 4 ][ yP + overlapSize ][ xP + overlapSize ] = inpCbVal
          inputTensor[ 0 ][ i ][ 5 ][ yP + overlapSize ][ xP + overlapSize ] = inpCrVal
        } else {
          inputTensor[ 0 ][ i ][ yP + overlapSize ][ xP + overlapSize ][ 0 ] = inpTLVal
          inputTensor[ 0 ][ i ][ yP + overlapSize ][ xP + overlapSize ][ 1 ] = inpTRVal
          inputTensor[ 0 ][ i ][ yP + overlapSize ][ xP + overlapSize ][ 2 ] = inpBLVal
          inputTensor[ 0 ][ i ][ yP + overlapSize ][ xP + overlapSize ][ 3 ] = inpBRVal
          inputTensor[ 0 ][ i ][ yP + overlapSize ][ xP + overlapSize ][ 4 ] = inpCbVal
          inputTensor[ 0 ][ i ][ yP + overlapSize ][ xP + overlapSize ][ 5 ] = inpCrVal
        }
        if( nnpfc_auxiliary_inp_idc = = 1 )
          if( !nnpfc_component_last_flag )
            inputTensor[ 0 ][ i ][ 6 ][ yP + overlapSize ][ xP + overlapSize ] = StrengthControlVal
          else
            inputTensor[ 0 ][ i ][ yP + overlapSize ][ xP + overlapSize ][ 6 ] = StrengthControlVal
      }
}
```

nnpfc_separate_colour_description_present_flag equal to 1 indicates that a distinct combination of colour primaries, transfer characteristics, and matrix coefficients for the picture resulting from the post-processing filter is specified in the SEI message syntax structure. nnfpc_separate_colour_description_present_flag equal to 0 indicates that the combination of colour primaries, transfer characteristics, and matrix coefficients for the picture resulting from the post-processing filter is the same as indicated in VUI parameters for the CLVS. nnpfc_colour_primaries has the same semantics as specified in subclause 7.3 for the vui_colour_primaries syntax element, except as follows:
nnpfc_colour_primaries specifies the colour primaries of the picture resulting from applying the neural-network post-filter specified in the SEI message, rather than the colour primaries used for the CLVS.
When nnpfc_colour_primaries is not present in the NNPFC SEI message, the value of nnpfc_colour_primaries is inferred to be equal to vui_colour_primaries.

nnpfc_transfer_characteristics has the same semantics as specified in subclause 7.3 for the vui_transfer_characteristics syntax element, except as follows:
nnpfc_transfer_characteristics specifies the transfer characteristics of the picture resulting from applying the neural-network post-filter specified in the SEI message, rather than the transfer characteristics used for the CLVS.
When nnpfc_transfer_characteristics is not present in the NNPFC SEI message, the value of nnpfc_transfer_characteristics is inferred to be equal to vui_transfer_characteristics.

nnpfc_matrix_coeffs has the same semantics as specified in subclause 7.3 for the vui_matrix_coeffs syntax element, except as follows:
nnpfc_matrix_coeffs specifies the matrix coefficients of the picture resulting from applying the neural-network post-filter specified in the SEI message, rather than the matrix coefficients used for the CLVS.

When nnpfc_matrix_coeffs is not present in the NNPFC SEI message, the value of nnpfc_matrix_coeffs is inferred to be equal to vui_matrix_coeffs.
The values allowed for nnpfc_matrix_coeffs are not constrained by the chroma format of the decoded video pictures that is indicated by the value of ChromaFormatIdc for the semantics of the VUI parameters.
When nnpfc_matrix_coeffs is equal to 0, nnpfc_out_order_idc shall not be equal to 1 or 3.

nnpfc_out_format_idc equal to 0 indicates that the sample values output by the post-processing filter are real numbers where the value range of 0 to 1, inclusive, maps linearly to the unsigned integer value range of 0 to (1<<bitDepth)−1, inclusive, for any desired bit depth bitDepth for subsequent post-processing or displaying. nnpfc_out_format_flag equal to 1 indicates that the sample values output by the post-processing filter are unsigned integer numbers in the range of 0 to (1<< (nnpfc_out_tensor_bitdepth_minus8+8))−1, inclusive.

Values of nnpfc_out_format_idc greater than 1 are reserved for future specification by ITU-T | ISO/IEC and shall not be present in bitstreams conforming to this edition of this document. Decoders conforming to this edition of this document shall ignore NNPFC SEI messages that contain reserved values of nnpfc_out_format_idc. nnpfc_out_tensor_bitdepth_minus8 plus 8 specifies the bit depth of sample values in the output integer tensor.

The value of nnpfc_out_tensor_bitdepth_minus8 shall be in the range of 0 to 24, inclusive. nnpfc_out_order_idc indicates the output order of samples resulting from the post-processing filter.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T | ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose is equal to 2 or 4, nnpfc_out_order_idc shall not be equal to 3.

Table 2-3 contains an informative description of nnpfc_out_order_idc values.

TABLE 2-3
Description of nnpfc_out_order_idc values

| nnpfc_out | |
|---|---|
| order_idc | Description |
| 0 | Only the luma matrix is present in the output |
| | tensor, thus the number of channels is 1. |
| 1 | Only the chroma matrices are present in the |
| | output tensor, thus the number of channels is 2. |
| 2 | The luma and chroma matrices are present in the |
| | output tensor, thus the number of channels is 3. |
| 3 | Four luma matrices and two chroma matrices |
| | are present in the output tensor, thus the number |
| | of channels is 6. This nnpfc_out_order_idc can |
| | only be used when the chroma format is 4:2:0. |
| 4 . . . 255 | Reserved |

The process StoreOutputTensors( ) for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < numInputPics; i++ ) {
  if( nnpfc_out_order_idc = = 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfc_pic_height_in_luma_samples && xY < nnpfc_pic_width_in_luma_samples )
          if( !nnpfc_component_last_flag )
            FilteredYPic[ i ][ xY ][yY ] = outputTensor[ 0 ][ i ][ 0 ][ yP ][ xP ]
          else
            FilteredYPic[ i ][ xY ][ yY ] = outputTensor[ 0 ][ i ][ yP ][ xP ][ 0 ]
      }
```

| | |
|---|---|
| else if( nnpfc_out_order_idc = = 1 ) | (83) |

```
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfc_pic_height_in_luma_samples / outSubHeightC &&
            xSrc < nnpfc_pic_width_in_luma_samples / outSubWidthC )
          if( !nnpfc_component_last_flag ) {
            FilteredCbPic[ i ][ xSrc ][ ySrc ] = outputTensor[ 0 ][ i ][ 0 ][ yP ][ xP ]
            FilteredCrPic[ i ][ xSrc ][ ySrc ] = outputTensor[ 0 ][ i ][ 1 ][ yP ][ xP ]
          } else {
            FilteredCbPic[ i ][ xSrc ][ ySrc ] = outputTensor[ 0 ][ i ][ yP ][ xP ][ 0 ]
            FilteredCrPic[ i ][ xSrc ][ ySrc ] = outputTensor[ 0 ][ i ][ yP ][ xP ][ 1 ]
          }
      }
  else if( nnpfc_out_order_idc = = 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = ( yP / outSubHeightC ) * outSubHeightC
        xPc = ( xP / outSubWidthC ) * outSubWidthC
        if ( yY < nnpfc_pic_height_in_luma_samples && xY < nnpfc_pic_width_in_luma_samples)
          if( !nnpfc_component_last_flag ) {
            FilteredYPic[ i ][ xY ][ yY ] = outputTensor[ 0 ][ i ][ 0 ][ yP ][ xP ]
            FilteredCbPic[ i ][ xC ][ yC ] = outputTensor[ 0 ][ i ][ 1 ][ yPc ][ xPc ]
            FilteredCrPic[ i ][ xC ][ yC ] = outputTensor[ 0 ][ i ][ 2 ][ yPc ][ xPc ]
          } else {
            FilteredYPic[ i ][ xY ][ yY ] = outputTensor[ 0 ][ i ][ yP ][ xP ][ 0 ]
            FilteredCbPic[ i ][ xC ][ yC ] = outputTensor[ 0 ][ i ][ yPc ][ xPc ][ 1 ]
            FilteredCrPic[ i ][ xC ][ yC ] = outputTensor[ 0 ][ i ][ yPc ][ xPc ][ 2 ]
          }
      }
  else if( nnpfc_out_order_idc = = 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfc_pic_height_in_luma_samples / 2 &&
            xSrc < nnpfc_pic_width_in_luma_samples / 2 )
          if( !nnpfc_component_last_flag ) {
            FilteredYPic[ i ][ xSrc * 2 ][ ySrc * 2 ] = outputTensor[ 0 ][ i ][ 0 ][ yP ][ xP ]
            FilteredYPic[ i ][ xSrc * 2 + 1 ][ ySrc * 2 ] = outputTensor[ 0 ][ i ][ 1 ][ yP ][ xP ]
            FilteredYPic[ i ][ xSrc * 2 ][ ySrc * 2 + 1 ] = outputTensor[ 0 ][ i ][ 2 ][ yP ][ xP ]
            FilteredYPic[ i ][ xSrc * 2 + 1][ ySrc * 2 + 1 ] = outputTensor[ 0 ][ i ][ 3 ][ yP ][ xP ]
            FilteredCbPic[ i ][ xSrc ][ ySrc ] = outputTensor[ 0 ][ i ][ 4 ][ yP ][ xP ]
            FilteredCrPic[ i ][ xSrc ][ ySrc ] = outputTensor[ 0 ][ i ][ 5 ][ yP ][ xP ]
          } else {
            FilteredYPic[ i ][ xSrc * 2 ][ ySrc * 2 ] = outputTensor[ 0 ][ i ][ yP ][ xP ][ 0 ]
            FilteredYPic[ i ][ xSrc * 2 + 1 ][ ySrc * 2 ] = outputTensor[ 0 ][ i ][ yP ][ xP ][ 1 ]
            FilteredYPic[ i ][ xSrc * 2 ][ ySrc * 2 + 1 ] = outputTensor[ 0 ][ i ][ yP ][ xP ][ 2 ]
            FilteredYPic[ i ][ xSrc * 2 + 1][ ySrc * 2 + 1 ] = outputTensor[ 0 ][ i ][ yP ][ xP ][ 3 ]
            FilteredCbPic[ i ][ xSrc ][ ySrc ] = outputTensor[ 0 ][ i ][ yP ][ xP ][ 4 ]
            FilteredCrPic[ i ][ xSrc ][ ySrc ] = outputTensor[ 0 ][ i ][ yP ][ xP ][ 5 ]
          }
      }
}
```

nnpfc_constant_patch_size_flag equal to 1 indicates that the post-processing filter accepts exactly the patch size indicated by nnpfc_patch_width_minus1 and nnpfc_patch_height_minus1 as input. nnpfc_constant_patch_size_flag equal to 0 indicates that the post-processing filter accepts any patch size that is a positive integer multiple of the patch size indicated by nnpfc_patch_width_minus1 and nnpfc_patch_height_minus1 as input.

nnpfc_patch_width_minus1+1, when nnpfc_constant_patch_size_flag equal to 1, indicates the horizontal sample counts of the patch size required for the input to the post-processing filter. The value of nnpfc_patch_width_minus1 shall be in the range of 0 to Min (32766, CroppedWidth−1), inclusive. nnpfc_patch_height_minus1+1, when nnpfc_constant_patch_size_flag equal to 1, indicates the vertical sample counts of the patch size required for the input to the post-processing filter. The value of

nnpfc_patch_height_minus1 shall be in the range of 0 to Min (32766, CroppedHeight−1), inclusive.

Let the variables inpPatchWidth and inpPatchHeight be the patch size width and the patch size height, respectively.

If nnpfc_constant_patch_size_flag is equal to 0, the following applies:
The values of inpPatch Width and inpPatchHeight are either provided by external means not specified in this document or set by the post-processor itself.
The value of inpPatch Width shall be a positive integer multiple of nnpfc_patch_width_minus1+1 and shall be less than or equal to CroppedWidth. The value of inpPatchHeight shall be a positive integer multiple of nnpfc_patch_height_minus1+1 and shall be less than or equal to CroppedHeight.

Otherwise (nnpfc_constant_patch_size_flag is equal to 1), the value of inpPatchWidth is set equal to nnpfc_patch_width_minus1+1 and the value of inpPatchHeight is set equal to nnpfc_patch_height_minus1+1. nnpfc_overlap indicates the overlapping horizontal and vertical sample counts of adjacent input tensors of the post-processing filter. The value of nnpfc_overlap shall be in the range of 0 to 16383, inclusive. The variables outPatchWidth, outPatchHeight, horCScaling, verCScaling, outPatchCWidth, outPatchCHeight, and overlapSize are derived as follows:

| | |
|---|---|
| outPatchWidth = ( nnpfc_pic_width_in_luma_samples * inpPatchWidth ) / CroppedWidth | (84) |
| outPatchHeight = ( nnpfc_pic_height_in_luma_samples * inpPatchHeight ) / CroppedHeight | (85) |
| horCScaling = SubWidthC / outSub WidthC | (86) |
| verCScaling = SubHeightC / outSubHeightC | (87) |
| outPatchCWidth = outPatchWidth * horCScaling | |
| (88) | |
| outPatchCHeight = outPatchHeight * verCScaling | |
| (89) | |
| overlapSize = nnpfc_overlap | (90). |

It is a requirement of bitstream conformance that outPatchWidth*CroppedWidth shall be equal to nnpfc_pic_width_in_luma_samples*inpPatchWidth and outPatchHeight*CroppedHeight shall be equal to nnpfc_pic_height_in_luma_samples*inpPatchHeight.

nnpfc_padding_type indicates the process of padding when referencing sample locations outside the boundaries of the cropped decoded output picture as described in Table 2-4. The value of nnpfc_padding_type shall be in the range of 0 to 15, inclusive.

TABLE 2-4
Informative description of nnpfc_padding_type values

| nnpfc_padding_type | Description |
|---|---|
| 0 | zero padding |
| 1 | replication padding |
| 2 | reflection padding |
| 3 | wrap-around padding |
| 4 | fixed padding |
| 5 . . . 15 | Reserved |

nnpfc_luma_padding_val indicates the luma value to be used for padding when nnpfc_padding_type is equal to 4.

nnpfc_cb_padding_val indicates the Cb value to be used for padding when nnpfc_padding_type is equal to 4.

nnpfc_cr_padding_val indicates the Cr value to be used for padding when nnpfc_padding_type is equal to 4.

The function InpSample Val(y, x, picHeight, pic Width, croppedPic) with inputs being a vertical sample location y, a horizontal sample location x, a picture height picHeight, a picture width picWidth, and sample array croppedPic returns the value of sample Val derived as follows:
NOTE 6—For the inputs to the function InpSampleVal( ) the vertical location is listed before the horizontal location for compatibility with input tensor conventions of some inference engines.

```
if( nnpfc_padding_type = = 0 )
  if( y < 0 | | x < 0 || y >= picHeight | | x >= picWidth )
    sampleVal = 0
  else
```

| | |
|---|---|
| sampleVal = croppedPic[ x ][ y ] | (91) |

```
else if( nnpfc_padding_type = = 1 )
  sampleVal = croppedPic[ Clip3( 0, picWidth − 1, x ) ][ Clip3( 0, picHeight − 1, y ) ]
else if( nnpfc_padding_type = = 2 )
  sampleVal = croppedPic[ Reflect( picWidth − 1, x ) ][ Reflect( picHeight − 1, y ) ]
else if( nnpfc_padding_type = = 3 )
  if( y >= 0 && y < picHeight )
    sampleVal = croppedPic[ Wrap( picWidth − 1, x ) ][ y ]
else if( nnpfc_padding_type = = 4 )
  if( y < 0 | | x < 0 | | y >= picHeight | | x >= picWidth )
    sampleVal[ 0 ] = nnpfc_luma_padding_val
      sampleVal[ 1 ] = nnpfc_cb_padding_val
    sampleVal[ 2 ] = nnpfc_cr_padding_val
  else
    sampleVal = croppedPic[ x ][ y ].
```

The following example process may be used to filter the cropped decoded output picture patch-wise with the post-processing filter PostProcessingFilter( ) to generate the filtered picture, which contains Y, Cb, and Cr sample arrays FilteredYPic, FilteredCbPic, and FilteredCrPic, respectively, as indicated by nnpfc_out_order_idc.

```
if( nnpfc_inp_order_idc = = 0 )
  for( cTop = 0; cTop < CroppedHeight; cTop += inpPatchHeight )
    for( cLeft = 0; cLeft < CroppedWidth; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 1 )
  for( cTop = 0; cTop < CroppedHeight / SubHeightC; cTop += inpPatchHeight )
    for( cLeft = 0; cLeft < CroppedWidth / SubWidthC; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 2 )
```

| | |
|---|---|
| for( cTop = 0; cTop < CroppedHeight; cTop += inpPatchHeight) | (92) |

```
    for( cLeft = 0; cLeft < CroppedWidth; cLeft += inpPatchWidth) {
      DeriveInputTensors( )
      outputTensor = PostProcessingFilter( inputTensor )
      StoreOutputTensors( )
    }
else if( nnpfc_inp_order_idc = = 3 )
  for( cTop = 0; cTop < CroppedHeight; cTop += inpPatchHeight * 2 )
    for( cLeft = 0; cLeft < CroppedWidth; cLeft += inpPatchWidth * 2 ) {
      DeriveInputTensors( )
      outputTensor = PostProcessingFilter( inputTensor )
      StoreOutputTensors( )
    }
```

nnpfc_complexity_info_present_flag equal to 1 specifies that one or more syntax elements that indicate the complexity of the post-processing filter associated with the nnpfc_id are present.

nnpfc_complexity_info_present_flag equal to 0 specifies that no syntax elements that indicates the complexity of the post-processing filter associated with the nnpfc_id are present.

nnpfc_parameter_type_idc equal to 0 indicates that the neural network uses only integer parameters. nnpfc_parameter_type_flag equal to 1 indicates that the neural network may use floating point or integer parameters. nnpfc_parameter_type_idc equal to 2 indicates that the neural network uses only binary parameters. nnpfc_parameter_type_idc equal to 3 is reserved for future use by ITU-T | ISO/IEC and shall not be present in bitstreams conforming to this edition of this document. Decoders conforming to this edition of this document shall ignore NNPFC SEI messages with nnpfc_parameter_type_idc equal to 3.

nnpfc_log2_parameter_bit_length_minus3 equal to 0, 1, 2, and 3 indicates that the neural network does not use parameters of bit length greater than 8, 16, 32, and 64, respectively. When nnpfc_parameter_type_idc is present and nnpfc_log2_parameter_bit_length_minus3 is not present the neural network does not use parameters of bit length greater than 1.

nnpfc_num_parameters_idc indicates the maximum number of neural network parameters for the post processing filter in units of a power of 2048. nnpfc_num_parameters_idc equal to 0 indicates that the maximum number of neural network parameters is unknown. The value nnpfc_num_parameters_idc shall be in the range of 0 to 52, inclusive. Values of nnpfc_num_parameters_idc greater than 52 are reserved for future use by ITU-T | ISO/IEC and shall not be present in bitstreams conforming to this edition of this document. Decoders conforming to this edition of this document shall ignore NNPFC SEI messages with nnpfc_num_parameters_idc greater than 52.

If the value of nnpfc_num_parameters_idc is greater than zero, the variable maxNumParameters is derived as follows:

$$maxNumParameters = ( 2048 ≪ nnpfc\_num \_parameters \_idc ) - 1. \qquad ( 93 )$$

It is a requirement of bitstream conformance that the number of neural network parameters of the post-processing filter shall be less than or equal to maxNumParameters.

nnpfc_num_kmac_operations_idc greater than 0 indicates that the maximum number of multiply-accumulate operations per sample of the post-processing filter is less than or equal to nnpfc_num_kmac_operations_idc*1000. nnpfc_num_kmac_operations_idc equal to 0 indicates that the maximum number of multiply-accumulate operations of the network is unknown. The value of nnpfc_num_kmac_operations_idc shall be in the range of 0 to 2³²−1, inclusive.

nnpfc_total_kilobyte_size greater than 0 indicates a total size in kilobytes required to store the uncompressed parameters for the neural network. The total size in bits is a number equal to or greater than the sum of bits used to store each parameter. nnpfc_total_kilobyte_size is the total size in bits divided by 8000, rounded up. nnpfc_total_kilobyte_size equal to 0 indicates that the total size required to store the parameters for the neural network is unknown. The value of nnpfc_total_kilobyte_size shall be in the range of 0 to 2³²-1, inclusive. nnpfc_reserved_zero_bit_b shall be equal to 0 in bitstreams conforming to this edition of this document. Decoders shall ignore NNPFC SEI messages in which nnpfc_reserved_zero_bit_b is not equal to 0. nnpfc_payload_byte[i] contains the i-th byte of a bitstream conforming to ISO/IEC 15938-17. The byte sequence nnpfc_payload_byte[i] for all present values of i shall be a complete bitstream that conforms to ISO/IEC 15938-17.

### 8.29 Neural-Network Post-Filter Activation SEI Message

### 8.29.1 Neural-Network Post-Filter Activation SEI Message Syntax

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) { | |
| nnpfa_persistence_flag | u(1) |
| } | |

### 8.29.2 Neural-Network Post-Filter Activation SEI Message Semantics

The neural-network post-filter activation (NNPFA) SEI message activates or de-activates the possible use of the target neural-network post-processing filter, identified by nnpfa_target_id, for post-processing filtering of a set of pictures.
NOTE 1—There can be several NNPFA SEI messages present for the same picture, for example, when the post-processing filters are meant for different purposes or filter different colour components.

nnpfa_target_id indicates the target neural-network post-processing filter, which is specified by one or more neural-network post-processing filter characteristics SEI messages that pertain to the current picture and have nnpfc_id equal to nnfpa_target_id.

The value of nnpfa_target_id shall be in the range of 0 to 2³²−2, inclusive. Values of nnpfa_target_id from 256 to 511, inclusive, and from 2³¹ to 2³²−2, inclusive, are reserved for future use by ITU-T | ISO/IEC. Decoders conforming to this edition of this document encountering an NNPFA SEI message with nnpfa_target_id in the range of 256 to 511, inclusive, or in the range of 2³¹ to 2³²−2, inclusive, shall ignore the SEI message.

An NNPFA SEI message with a particular value of nnpfa_target_id shall not be present in a current PU unless one or both of the following conditions are true:
Within the current CLVS there is an NNPFC SEI message with nnpfc_id equal to the particular value of nnpfa_target_id present in a PU preceding the current PU in decoding order.
There is an NNPFC SEI message with nnpfc_id equal to the particular value of nnpfa_target_id in the current PU.

When a PU contains both an NNPFC SEI message with a particular value of nnpfc_id and an NNPFA SEI message with nnpfa_target_id equal to the particular value of nnpfc_id, the NNPFC SEI message shall precede the NNPFA SEI message in decoding order.

nnpfa_cancel_flag equal to 1 indicates that the persistence of the target neural-network post-processing filter established by any previous NNPFA SEI message with the same nnpfa_target_id as the current SEI message is cancelled, i.e., the target neural-network post-processing filter is no longer used unless it is activated by another NNPFA SEI message with the same nnpfa_target_id as the current SEI message and nnpfa_cancel_flag equal to 0. nnpfa_cancel_flag equal to 0 indicates that the nnpfa_persistence_flag follows.

nnpfa_persistence_flag specifies the persistence of the target neural-network post-processing filter for the current layer.

nnpfa_persistence_flag equal to 0 specifies that the target neural-network post-processing filter may be used for post-processing filtering for the current picture only.

nnpfa_persistence_flag equal to 1 specifies that the target neural-network post-processing filter may be used for post-processing filtering for the current picture and all subsequent pictures of the current layer in output order until one or more of the following conditions are true:
A new CLVS of the current layer begins.
The bitstream ends.
A picture in the current layer associated with a NNPFA SEI message with the same nnpfa_target_id as the current SEI message and nnpfa_cancel_flag equal to 1 is output that follows the current picture in output order.
NOTE 2—The target neural-network post-processing filter is not applied for this subsequent picture in the current layer associated with a NNPFA SEI message with the same nnpfa_target_id as the current SEI message and nnpfa_cancel_flag equal to 1.

### 4. Problems

The current design for the neural-network post-filter characteristics (NNPFC) SEI message and the neural-network post-filter activation (NNPFA) SEI message has the following problems:
1) An NNPF can be activated for a set of pictures. However, it is unclear how to apply the NNPF for all pictures in the set of pictures for which the NNPF is activated, particularly when multiple input pictures are specified. For example, is the NNPF to be applied for one picture at a time? For another example, in which order of the pictures should the NNPF be applied?
2) For the NNPF purpose of picture rate upsampling, a number of interpolated pictures between each pair of neighboring input pictures is specified. However, typically some pictures are interpolated between only one pair of input pictures even when more than two input pictures are utilized for the interpolation. In addition, doing more than interpolating some pictures between only one pair of input pictures can cause pictures between a particular pair of input pictures being interpolated more than once, which makes the process more unclear and confusing.
3) When a neural-network post-filter (NNPF) takes one picture as input, when applying the NNPF to a particular current picture for which the NNPF is activated, it is not clearly specified which picture is to be used as the input picture.
4) When a neural-network post-filter (NNPF) takes multiple pictures as input, when applying the NNPF to a particular picture for which the NNPF is activated, it is not clearly specified which pictures are to be used as the input pictures.
5) When a neural-network post-filter (NNPF) takes multiple pictures as input, when applying the NNPF to a particular current picture for which the NNPF is activated, it is possible that the total number of available pictures is less than the number of input pictures. This can happen when the total number of pictures for which the NNPF is activated is less than the number of input pictures, or when the current picture is the first or the last among the pictures for which the NNPF is activated. However, it is unclear how to apply the NNPF in such scenarios.

### 5. Detailed Solutions

To solve the above problems, methods as summarized below are disclosed. The solutions should be considered as examples to explain the general concepts and should not be interpreted in a narrow way. Furthermore, these solutions can be applied individually or combined in any manner.
1) To solve problem 1, one or more of the following aspects are specified:
   a. In one example, it is specified that, for an NNPF that is activated for a set of pictures, denoted as TargetPictures, the NNPF is applied to each of the pictures in TargetPictures, one at a time, in decoding order of the pictures in TargetPictures.
   b. In one example, alternatively, it is specified that, for an NNPF that is activated for a set of pictures, denoted as TargetPictures, the NNPF is applied to each group comprising a fixed number of consecutive pictures in TargetPictures, one group at a time, in decoding order of the pictures in TargetPictures.
   c. In one example, alternatively, it is specified that, for an NNPF that is activated for a set of pictures, denoted as TargetPictures, the NNPF is applied to each of the pictures in TargetPictures, one at a time, in output order of the pictures in TargetPictures.
   d. In one example, alternatively, it is specified that, for an NNPF that is activated for a set of pictures, denoted as TargetPictures, the NNPF is applied to each group comprising a fixed number of consecutive pictures in TargetPictures, one group at a time, in output order of the pictures in TargetPictures.
2) To solve problem 2, it is specified that, for the NNPF purpose of picture rate upsampling, some pictures are interpolated between only one pair of input pictures even when more than two input pictures are utilized for the interpolation.
   a. In one example, based on the current syntax of the NNPFC SEI message, it is required that nnpfc_interpolated_pics[i] shall be greater than 0 for only one of the i in the range of 0 to nnpfc_num_input_pics_minus2, inclusive; i.e., nnpfc_interpolated_pics[ i] shall be equal to 0 for all other values of i.
   b. In one example, it is specified that, some pictures are interpolated between only the middle pair of input pictures even when more than two input pictures are utilized for the interpolation.
      i. In one example, based on the current syntax of the NNPFC SEI message, it is required that nnpfc_interpolated_pics[i] shall be greater than 0 only when i is equal to 0 to nnpfc_num_input_pics_minus2/2; i.e., nnpfc_interpolated_pics[i] shall be equal to 0 for all other values of i.
      ii. In one example, the syntax of the NNPFC SEI message is changed such that only one instance of nnpfc_interpolated_pics[i] is signalled, e.g., using the syntax element name nnpfc_interpolated_pics_minus1, and nnpfc_interpolated_pics_minus1 plus 1 specifies the number of interpolated pictures between the middle pair of input pictures.
      iii. In one example, it is required that nnpfc_num_input_pics_minus2 shall be an even number, and the middle pair of input pictures are the and the nnpfc_num_input_pics_minus2/2-th input picture (nnpfc_num_input_pics_minus2/2+1)-th input picture.
3) To solve problem 3, it is specified that, when an NNPF takes one picture as input, when applying the NNPF to a particular current picture for which the NNPF is activated, the input picture is the current picture itself.
4) To solve problem 4, the pictures which are used as input pictures may be determined, specified or signalled.
   a. In one example, the identification of pictures which are used as input is signalled.
      i. In one example, each picture order count (POC) value of the input pictures is signalled.
      ii. In one example, the difference of POC values in the input pictures may be signalled.
         1. In one example, the POC difference between each input picture and the picture for which the NNPF is activated is signalled.
         2. In one example, the least POC values in the input pictures is signalled and the difference of rest POC values and the least POC values are signalled.
         3. In one example, the largest POC values in the input pictures is signalled and the difference of rest POC values and the largest POC values are signalled.
         4. In one example, the medium POC values in the input pictures is signalled and the difference of rest POC values and the medium POC values are signalled.
   b. In one example, the input pictures are specified and listed in output order.
      i. In one example, the pictures precede the current picture is listed in output order. The pictures succeed the current picture is listed in output order.
      ii. In one example, the pictures preceded the current picture is listed in decoding order. The pictures succeed the current picture is listed in output order.
      iii. In one example, the pictures preceded the current picture is listed in output order. The pictures succeed the current picture is listed in decoding order.
      iv. In one example, the pictures preceded the current picture is listed in decoding order. The pictures succeed the current picture is listed in decoding order.
5) To solve problem 2, the interpolated pictures generated by the post-processing filter may be specified or signalled.
   a. In one example, one or more syntax elements are signalled to specify the interpolated pictures.
      i. In one example, the least and largest POC values of interpolated pictures are signalled.
      ii. In one example, the least POC value of interpolated pictures is signalled and the largest POC value of interpolated pictures can be derived by the number of interpolated pictures which is signalled in the NNPFC SEI message.
   b. In one example, the interpolated pictures may be determined by the input pictures.
      i. In one example, the interpolated pictures lie between the middle pair of input pictures.
         1. In one example, the input pictures with the index of

$$[ \frac{N}{2} ] and [ \frac{N}{2} ] + 1$$

consist of the middle pair of input pictures, where N is integer denotes the number of input pictures and └x┘ denotes the greatest integer less than or equal to x.
ii. In one example, the interpolated pictures lie between the first pair of input pictures.
iii. In one example, the interpolated pictures lie between the last pair of input pictures.
iv. In one example, the pictures are interpolated between any pair of consecutive input pictures and the identification of this pair is signalled.
   1. In one example, the POC values of input pictures in the pair are signalled.
   2. In one example, the index of the first input picture in the pair is signalled.
6) To solve problem 5, one or more following methods may be used for generation of the unavailable input pictures.
   a. In one example, padding method may be used.
      i. In one example, the unavailable pictures may be replaced with closest available picture in the order of decoding order.
      ii. In one example, the unavailable pictures may be replaced with available picture with the lowest QP in the order of decoding order.
      iii. In one example, the unavailable pictures may be padded with a default value.
         1. In one example, the default value is normalized.
         a. In one example, the default value is 0.
         b. In one example, the default value is 0.5.
         c. In one example, the default value is 1.
         2. In one example, the default value is not normalized, and it ranges from 0 to N−1, inclusive, where N is an integer.
         a. In one example, furthermore, the N is specified to 1<<(nnpfc_inp_tensor_bitdepth_minus8+8).
   b. In one example, the unavailable pictures may be interpolated with existing available pictures.
      i. In one example, the bilinear filter may be used for interpolation.
      ii. In one example, the bicubic filter may be used for interpolation.
      iii. In one example, the Lanczos filter may be used for interpolation.
      iv. In one example, neural network based interpolation filter may be used for interpolation.

### 6. Embodiments

Below are some example embodiments for the solutions aspects summarized above in Section 5.

Most relevant parts that have been added or modified are shown in using bolded words (e.g., this format indicates added text), and some of the deleted parts are shown by using words in italics between double curly brackets (e.g., {{this format indicates deleted text}}) . . . . There may be some other changes that are editorial in nature and thus not highlighted. It should be understood that only markings in this section are intended to represent changes.

### Embodiment 1

This embodiment is for the solution items 4, 5, and 6 and all their subitems summarized above in Section 5.

### 8.29.1 Neural-Network Post-Filter Activation SEI Message Syntax

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) {{ { }} | |
| nnpfa_persistence_flag | u(1) |
| } | |
| nnpfa_{—}num_{—}input_{—}pics_{—}minus1 | ue(v) |
| if(nnpfa_{—}num_{—}input_{—}pics_{—}minus1 > 0) { | |
| for( i = 0; i <= nnpfa_{—}num_{—}input_{—}pics_{—}minus1; i++) | |
| nnpfa_{—}input_{—}pics_{—}poc[ i ] | ue(v) |
| nnpfa_{—}least_{—}output_{—}pics_{—}poc | ue(v) |
| nnpfa_{—}largest_{—}output_{—}pics_{—}poc | ue(v) |
| } | |
| ... | |
| } | |

8.29.2 Neural-network post-filter activation SEI message semantics
. . .

nnpfa_num_input_pics_minus1 plus 1 specifies the number of decoded output pictures used as input for the post-processing filter. The value of nnpfa_num_input_pics_minus1 shall be in the range of 0 to 15, inclusive.

nnpfa_input_pics_poc[i] specifies the POC value of input pictures. The value of nnpfa_input_pics_poc[i] shall be in the range of 0 to 2³²−1, inclusive.

nnpfa_least_output_pics_poc specifies the least POC value of interpolated pictures. The value of nnpfa_least_output_pics_poc shall be in the range of 0 to 2³²−1, inclusive.

nnpfa_largest_output_pics_poc specifies the largest POC value of interpolated pictures. The value of nnpfa_largest_output_pics_poc shall be in the range of 0 to 2³²−1, inclusive.

The terms ‘video unit’ or ‘coding unit’ or ‘block’ may represent a coding tree block (CTB), a coding tree unit (CTU), a coding block (CB), a CU, a PU, a TU, a PB, a TB.

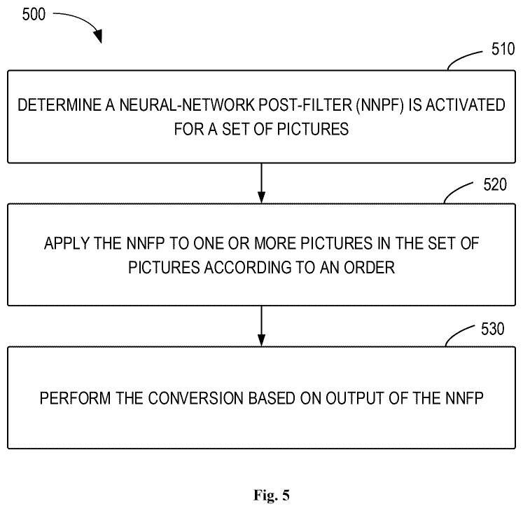

FIG. 5 illustrates a flowchart of a method 500 for video processing in accordance with embodiments of the present disclosure. The method 500 is implemented during a conversion between a video unit of a video and a bitstream of the video.

At block 510, for a conversion between a video unit of a video and a bitstream of the video, a neural-network post-filter (NNPF) is determined being activated for a set of pictures.

At block 520, the NNPF is applied to one or more pictures in the set of pictures according to an order.

At block 530, the conversion is performed based on output of the NNPF. In some embodiments, the conversion may include encoding the video unit into the bitstream. Alternatively, or in addition, the conversion may include decoding the video unit from the bitstream. In this way, it specifies how to apply the NNPF and improves coding efficiency and performance.

In some embodiments, the NNPF is applied to each picture in the set of pictures in an output order of pictures in the set of pictures, and the NNPF is applied to one picture at a time. For example, BitstreamToFilter is decoded, and the list CroppedDecodedPictures is set to be the list of the cropped decoded pictures in output order resulted from decoding BitstreamToFilter. Further, the filtering process for one picture is repeatedly invoked, in output order, for each cropped decoded picture that is in CroppedDecodedPictures and for which one or more NNPFs are activated.

In some embodiments, the NNPF is applied to each picture in the set of pictures in a decoding order of pictures in the set of pictures, and the NNPF is applied to one picture at a time. In some other embodiments, the NNPF is applied to each group comprising a fixed number of consecutive pictures in the set of pictures in a decoding order of pictures in the set of pictures, and the NNPF is applied to one group at a time. Alternatively, the NNPF is applied to each group comprising a fixed number of consecutive pictures in the set of pictures in an output order of pictures in the set of pictures, and the NNPF is applied to one group at a time.

In some embodiments, if the NNPF takes one picture as input, and if the NNPF is applied to a current picture for which the NNPF is activated, an input picture of the NNPF is the current picture. For example, filtered and/or interpolated pictures are generated by the NNPF by applying the NNPF process specified in the semantics of the NNPFC SEI message, in a patch-wise manner, to the current picture.

In some embodiments, pictures which are used as input pictures of the NNPF are determined. Alternatively, pictures which are used as input pictures of the NNPF are specified. In some other embodiments, pictures which are used as input pictures of the NNPF are indicated.

In some embodiments, the input pictures are specified and listed in output order. For example, the order of the pictures in ListNnpfOutputPics is in output order.

In some embodiments, one or more pictures before the current picture are listed in output order, and one or more pictures after the current picture are listed in output order. In some other embodiments, one or more pictures before the current picture are listed in decoding order, one or more pictures after the current picture are listed in output order. Alternatively, one or more pictures before the current picture are listed in output order, one or more pictures after the current picture are listed in decoding order. In some embodiments, one or more pictures before the current picture are listed in decoding order, and one or more pictures after the current picture are listed in decoding order.

In some embodiments, one or more identifications related to the pictures which are used as input are indicated. For example, each picture order count (POC) value of the input pictures is indicated.

In some embodiments, a difference related to POC values in the input pictures are indicated. For example, a POC difference between each input picture and a picture for which the NNPF is activated is indicated. As another example, a least POC value in the input pictures is indicated, and a difference between a rest POC value and the least POC value is indicated. As a further example, a largest POC value in the input pictures is indicated, and a difference between a rest POC value and the largest POC value is indicated. As another example, a medium POC value in the input pictures is indicated, and a difference between a rest POC value and the medium POC value is indicated.

In some embodiments, for an NNPF purpose of picture rate upsampling, one or more pictures are interpolated between one pair of input pictures, even if more than two input pictures are utilized for the interpolation. For example, a syntax of an post-filter characteristics (NNPFC) supplemental enhancement information (SEI) message requires that each of an i-th NNPFC interpolated pictures which is represented as nnpfc_interpolated_pics[i] is greater than 0 for only one of the i in the range of 0 to NNPFC number of input pictures minus two which is represented as nnpfc_num_input_pics_minus2, inclusive, where i is an integer number. In other words, the i-th NNPFC interpolated pictures (i.e., nnpfc_interpolated_pics[i]) is equal to 0 for all other values of i.

In some other embodiments, for an NNPF purpose of picture rate upsampling, one or more pictures are interpolated between a middle pair of input pictures, even if more than two input pictures are utilized for the interpolation. For example, a syntax of an NNPFC SEI message requires that each of an i-th NNPFC interpolated pictures which is represented as nnpfc_interpolated_pics[i] is greater than 0 for only if i is equal to 0 to NNPFC number of input pictures minus two divided by 2 which is represented as nnpfc_num_input_pics_minus2/2, where i is an integer number. In other words, the i-th NNPFC interpolated pictures (i.e., nnpfc_interpolated_pics[i]) is equal to 0 for all other values of i.

In some embodiments, only one instance of i-th NNPFC interpolated pictures which is represented as nnpfc_interpolated_pics[i] is indicated in an NNPFC SEI message. For example, a syntax element which is represented as nnpfc_interpolated_pics_minus1 may be indicted in the NNPFC SEI message. In this case, nnpfc_interpolated_pics_minus1 plus 1 may specify the number of interpolated pictures between the middle pair of input pictures. In some other embodiments, nnpfc_num_input_pics_minus2 is an even number, and the middle pair of input pictures are the nnpfc_num_input_pics_minus2/2-th input picture and the (nnpfc_num_input_pics_minus2/2+1)-th input picture.

In some embodiments, interpolated pictures generated by a post-processing filter are specified. Alternatively, the interpolated pictures generated by the NNPF are indicated.

In some embodiments, one or more syntax elements are indicated to specify the interpolated pictures. For example, a least POC value and a largest POC value of the interpolated pictures are indicated. As another example, a least POC value of the interpolated pictures is indicated, and a largest POC value of the interpolated pictures is derived based on the number of interpolated pictures which is indicated in an NNPFC SEI message.

In some embodiments, the interpolated pictures are determined based on input pictures. For example, the interpolated pictures are between the middle pair of input pictures. In an example embodiment, the input pictures with the index of └N/2┘ and └N/2┘+1 comprises the middle pair of input pictures, where N is an integer number and represents the number of input pictures and └x┘ represents a greatest integer less than or equal to x.

In some embodiments, the interpolated pictures are between a first pair of input pictures. In some other embodiments, the interpolated pictures are between a last pair of input pictures.

In some embodiments, pictures are interpolated between a pair of consecutive input pictures and an identification of the pair is indicated. For example, POC values of input pictures in the pair are indicated. As another example, an index of a first input picture in the pair is indicated.

In some embodiments, a padding approach is used for generation of unavailable input pictures. For example, the unavailable pictures are replaced with closest available picture in an order of decoding order. As another example, the unavailable pictures are replaced with available picture with a lowest quantization parameter (QP) in an order of decoding order.

In some embodiments, the unavailable pictures are padded with a default value. For example, the default value is normalized. In an example, the default value is 0. Alternatively, the default value is 0.5. As another example, the default value is 1.

In some embodiments, the default value is not normalized and in a range from 0 to N-1, inclusive, where N is an integer. In some embodiments, the N is specified to 1<< (nnpfc_inp_tensor_bitdepth_minus8+8).

In some embodiments, unavailable pictures are interpolated with existing available pictures. For example, a bilinear filter is used for interpolation of the unavailable pictures. As another example, a bicubic filter is used for interpolation of the unavailable pictures. As a further example, a Lanczos filter is used for interpolation of the unavailable pictures. By way of example, a neural network based interpolation filter is used for interpolation of the unavailable pictures.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a neural-network post-filter (NNPF) is activated for a set of pictures related to a video unit of the video; apply the NNPF to one or more pictures in the set of pictures according to an order; and generating the bitstream based on output of the NNPF.

According to still further embodiments of the present disclosure, a method for storing bitstream of a video is provided. The method comprises: determining a neural-network post-filter (NNPF) is activated for a set of pictures related to a video unit of the video; apply the NNPF to one or more pictures in the set of pictures according to an order; generating the bitstream based on output of the NNPF; and storing the bitstream in a non-transitory computer-readable medium.

Implementations of the present disclosure can be described in view of the following clauses, the features of which can be combined in any reasonable manner.

Clause 1. A method for video processing, comprising: determining, for a conversion between a video unit of a video and a bitstream of the video, a neural-network post-filter (NNPF) is activated for a set of pictures; apply the NNPF to one or more pictures in the set of pictures according to an order; and performing the conversion based on the NNPF.

Clause 2. The method of clause 1, wherein the NNPF is applied to each picture in the set of pictures in an output order of pictures in the set of pictures, and the NNPF is applied to one picture at a time.

Clause 3. The method of clause 1, wherein the NNPF is applied to each picture in the set of pictures in a decoding order of pictures in the set of pictures, and the NNPF is applied to one picture at a time.

Clause 4. The method of clause 1, wherein the NNPF is applied to each group comprising a fixed number of consecutive pictures in the set of pictures in a decoding order of pictures in the set of pictures, and the NNPF is applied to one group at a time.

Clause 5. The method of clause 1, wherein the NNPF is applied to each group comprising a fixed number of consecutive pictures in the set of pictures in an output order of pictures in the set of pictures, and the NNPF is applied to one group at a time.

Clause 6. The method of any of clauses 1-5, wherein if the NNPF takes one picture as input, and if the NNPF is applied to a current picture for which the NNPF is activated, an input picture of the NNPF is the current picture.

Clause 7. The method of any of clauses 1-6, wherein pictures which are used as input pictures of the NNPF are determined, or wherein pictures which are used as input pictures of the NNPF are specified, or wherein pictures which are used as input pictures of the NNPF are indicated.

Clause 8. The method of clause 7, wherein the input pictures are specified and listed in output order.

Clause 9. The method of clause 8, wherein one or more pictures before the current picture are listed in output order, and one or more pictures after the current picture are listed in output order.

Clause 10. The method of clause 8, wherein one or more pictures before the current picture are listed in decoding order, one or more pictures after the current picture are listed in output order.

Clause 11. The method of clause 8, wherein one or more pictures before the current picture are listed in output order, one or more pictures after the current picture are listed in decoding order.

Clause 12. The method of clause 8, wherein one or more pictures before the current picture are listed in decoding order, and one or more pictures after the current picture are listed in decoding order.

Clause 13. The method of clause 7, wherein one or more identifications related to the pictures which are used as input are indicated.

Clause 14. The method of clause 13, wherein each picture order count (POC) value of the input pictures is indicated.

Clause 15. The method of clause 13, wherein a difference related to POC values in the input pictures are indicated.

Clause 16. The method of clause 15, wherein a POC difference between each input picture and a picture for which the NNPF is activated is indicated.

Clause 17. The method of clause 15, wherein a least POC value in the input pictures is indicated, and a difference between a rest POC value and the least POC value is indicated.

Clause 18. The method of clause 15, wherein a largest POC value in the input pictures is indicated, and a difference between a rest POC value and the largest POC value is indicated.

Clause 19. The method of clause 15, wherein a medium POC value in the input pictures is indicated, and a difference between a rest POC value and the medium POC value is indicated.

Clause 20. The method of any of clauses 1-19, wherein for an NNPF purpose of picture rate upsampling, one or more pictures are interpolated between one pair of input pictures, even if more than two input pictures are utilized for the interpolation.

Clause 21. The method of clause 20, wherein a syntax of an post-filter characteristics (NNPFC) supplemental enhancement information (SEI) message requires that each of an i-th NNPFC interpolated pictures which is represented as nnpfc_interpolated_pics[i] is greater than 0 for only one of the i in the range of 0 to NNPFC number of input pictures minus two which is represented as nnpfc_num_input_pics_minus2, inclusive, wherein i is an integer number.

Clause 22. The method of clause 21, wherein the i-th NNPFC interpolated pictures is equal to 0 for all other values of i.

Clause 23. The method of any of clauses 1-19, wherein for an NNPF purpose of picture rate upsampling, one or more pictures are interpolated between a middle pair of input pictures, even if more than two input pictures are utilized for the interpolation.

Clause 24. The method of clause 23, wherein a syntax of an NNPFC SEI message requires that each of an i-th NNPFC interpolated pictures which is represented as nnpfc_interpolated_pics[i] is greater than 0 for only if i is equal to 0 to NNPFC number of input pictures minus two divided by 2 which is represented as nnpfc_num_input_pics_minus2/2, wherein i is an integer number.

Clause 25. The method of clause 23, wherein only one instance of i-th NNPFC interpolated pictures which is represented as nnpfc_interpolated_pics[i] is indicated in an NNPFC SEI message.

Clause 26. The method of clause 25, wherein a syntax element which is represented as nnpfc_interpolated_pics_minus1 is indicted in the NNPFC SEI message, and wherein nnpfc_interpolated_pics_minus1 plus 1 specifies the number of interpolated pictures between the middle pair of input pictures.

Clause 27. The method of clause 23, wherein nnpfc_num_input_pics_minus2 is an even number, and the middle pair of input pictures are the nnpfc_num_input_pics_minus2/2-th input picture and the (nnpfc_num_input_pics_minus2/2+1)-th input picture.

Clause 28. The method of any of clauses 1-27, wherein interpolated pictures generated by a post-processing filter are specified, or wherein the interpolated pictures generated by the NNPF are indicated.

Clause 29. The method of clause 28, wherein one or more syntax elements are indicated to specify the interpolated pictures.

Clause 30. The method of clause 29, wherein a least POC value and a largest POC value of the interpolated pictures are indicated.

Clause 31. The method of clause 29, wherein a least POC value of the interpolated pictures is indicated, and a largest POC value of the interpolated pictures is derived based on the number of interpolated pictures which is indicated in an NNPFC SEI message.

Clause 32. The method of clause 28, wherein the interpolated pictures are determined based on input pictures.

Clause 33. The method of clause 32, wherein the interpolated pictures are between the middle pair of input pictures.

Clause 34. The method of clause 33, wherein the input pictures with the index of

$$[ \frac{N}{2} ] and [ \frac{N}{2} ] + 1$$

comprises the middle pair of input pictures, wherein N is an integer number and represents the number of input pictures and └x┘ represents a greatest integer less than or equal to x.

Clause 35. The method of clause 32, wherein the interpolated pictures are between a first pair of input pictures.

Clause 36. The method of clause 32, wherein the interpolated pictures are between a last pair of input pictures.

Clause 37. The method of clause 32, wherein pictures are interpolated between a pair of consecutive input pictures and an identification of the pair is indicated.

Clause 38. The method of clause 37, wherein POC values of input pictures in the pair are indicated.

Clause 39. The method of clause 37, wherein an index of a first input picture in the pair is indicated.

Clause 40. The method of any of clauses 1-39, wherein a padding approach is used for generation of unavailable input pictures.

Clause 41. The method of clause 40, wherein the unavailable pictures are replaced with closest available picture in an order of decoding order.

Clause 42. The method of clause 40, wherein the unavailable pictures are replaced with available picture with a lowest quantization parameter (QP) in an order of decoding order.

Clause 43. The method of clause 40, wherein the unavailable pictures are padded with a default value.

Clause 44. The method of clause 43, wherein the default value is normalized.

Clause 45. The method of clause 44, wherein the default value is 0, or wherein the default value is 0.5, or wherein the default value is 1.

Clause 46. The method of clause 43, wherein the default value is not normalized and in a range from 0 to N−1, inclusive, where N is an integer.

Clause 47. The method of clause 46, wherein the N is specified to 1<< (nnpfc_inp_tensor_bitdepth_minus8+8).

Clause 48. The method of any of clauses 1-39, wherein unavailable pictures are interpolated with existing available pictures.

Clause 49. The method of clause 48, wherein a bilinear filter is used for interpolation of the unavailable pictures.

Clause 50. The method of clause 48, wherein a bicubic filter is used for interpolation of the unavailable pictures.

Clause 51. The method of clause 48, wherein a Lanczos filter is used for interpolation of the unavailable pictures.

Clause 52. The method of clause 48, wherein a neural network based interpolation filter is used for interpolation of the unavailable pictures.

Clause 53. The method of any of clauses 1-52, wherein the conversion includes encoding the video unit into the bitstream.

Clause 54. The method of any of clauses 1-52, wherein the conversion includes decoding the video unit from the bitstream.

Clause 55. An apparatus for video processing comprising a processor and a non-transitory memory with instructions thereon, wherein the instructions upon execution by the processor, cause the processor to perform a method in accordance with any of clauses 1-54.

Clause 56. A non-transitory computer-readable storage medium storing instructions that cause a processor to perform a method in accordance with any of clauses 1-54.

Clause 57. A non-transitory computer-readable recording medium storing a bitstream of a video which is generated by a method performed by an apparatus for video processing, wherein the method comprises: determining a neural-network post-filter (NNPF) is activated for a set of pictures related to a video unit of the video; apply the NNPF to one or more pictures in the set of pictures according to an order; and generating the bitstream based on output of the NNPF.

Clause 58. A method for storing a bitstream of a video, comprising: determining a neural-network post-filter (NNPF) is activated for a set of pictures related to a video unit of the video; apply the NNPF to one or more pictures in the set of pictures according to an order; generating the bitstream based on output of the NNPF; and storing the bitstream in a non-transitory computer-readable medium.

### Example Device

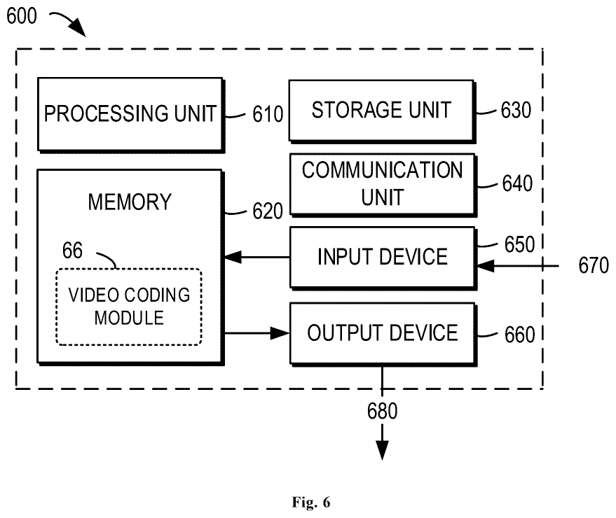

FIG. 6 illustrates a block diagram of a computing device 600 in which various embodiments of the present disclosure can be implemented. The computing device 600 may be implemented as or included in the source device 110 (or the video encoder 114 or 200) or the destination device 120 (or the video decoder 124 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement video encoding/decoding in embodiments of the present disclosure. The memory 620 may include one or more video coding modules 625 having one or more program instructions. These modules are accessible and executable by the processing unit 610 to perform the functionalities of the various embodiments described herein.

In the example embodiments of performing video encoding, the input device 650 may receive video data as an input 670 to be encoded. The video data may be processed, for example, by the video coding module 625, to generate an encoded bitstream. The encoded bitstream may be provided via the output device 660 as an output 680.

In the example embodiments of performing video decoding, the input device 650 may receive an encoded bitstream as the input 670. The encoded bitstream may be processed, for example, by the video coding module 625, to generate decoded video data. The decoded video data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a video unit of a video and a bitstream of the video, a neural-network post-filter (NNPF) is activated for a set of pictures related to the video unit;
apply the NNPF to one or more pictures in the set of pictures according to an order; and
performing the conversion based on output of the NNPF.

2. The method of claim 1, wherein the NNPF is applied to each picture in the set of pictures in an output order of pictures in the set of pictures, and the NNPF is applied to one picture at a time.

3. The method of claim 1, wherein if the NNPF takes one picture as input, and if the NNPF is applied to a current picture for which the NNPF is activated, an input picture of the NNPF is the current picture.

4. The method of claim 1, wherein pictures which are used as input pictures of the NNPF are determined, or
wherein pictures which are used as input pictures of the NNPF are specified, or
wherein pictures which are used as input pictures of the NNPF are indicated, and
wherein the input pictures are specified and listed in output order.

5. The method of claim 4, wherein one or more pictures before the current picture are listed in output order, and one or more pictures after the current picture are listed in output order.

6. The method of claim 5, wherein one or more pictures before the current picture are listed in decoding order, one or more pictures after the current picture are listed in output order, and/or
wherein one or more pictures before the current picture are listed in output order, one or more pictures after the current picture are listed in decoding order, and/or
wherein one or more pictures before the current picture are listed in decoding order, and one or more pictures after the current picture are listed in decoding order.

7. The method of claim 4, wherein one or more identifications related to the pictures which are used as input are indicated.

8. The method of claim 7, wherein each picture order count (POC) value of the input pictures is indicated, and/or
wherein a difference related to POC values in the input pictures are indicated.

9. The method of claim 8, wherein a POC difference between each input picture and a picture for which the NNPF is activated is indicated, and/or
wherein a least POC value in the input pictures is indicated, and a difference between a rest POC value and the least POC value is indicated, and/or
wherein a largest POC value in the input pictures is indicated, and a difference between a rest POC value and the largest POC value is indicated, and/or
wherein a medium POC value in the input pictures is indicated, and a difference between a rest POC value and the medium POC value is indicated.

10. The method of claim 1, wherein the NNPF is applied to each picture in the set of pictures in a decoding order of pictures in the set of pictures, and the NNPF is applied to one picture at a time, and/or
wherein the NNPF is applied to each group comprising a fixed number of consecutive pictures in the set of pictures in a decoding order of pictures in the set of pictures, and the NNPF is applied to one group at a time, and/or
wherein the NNPF is applied to each group comprising a fixed number of consecutive pictures in the set of pictures in an output order of pictures in the set of pictures, and the NNPF is applied to one group at a time, and/or
wherein for an NNPF purpose of picture rate upsampling, one or more pictures are interpolated between one pair of input pictures, even if more than two input pictures are utilized for the interpolation, and/or
wherein for an NNPF purpose of picture rate upsampling, one or more pictures are interpolated between a middle pair of input pictures, even if more than two input pictures are utilized for the interpolation, and/or
wherein interpolated pictures generated by a post-processing filter are specified, or the interpolated pictures generated by the NNPF are indicated, and/or
wherein a padding approach is used for generation of unavailable input pictures, and/or
wherein unavailable pictures are interpolated with existing available pictures.

11. The method of claim 10, wherein a syntax of an post-filter characteristics (NNPFC) supplemental enhancement information (SEI) message requires that each of an i-th NNPFC interpolated pictures which is represented as nnpfc_interpolated_pics[i] is greater than 0 for only one of the i in the range of 0 to NNPFC number of input pictures minus two which is represented as nnpfc_num_input_pics_minus2, inclusive, wherein i is an integer number, and/or
wherein a syntax of an NNPFC SEI message requires that each of an i-th NNPFC interpolated pictures which is represented as nnpfc_interpolated_pics[i] is greater than 0 for only if i is equal to 0 to NNPFC number of input pictures minus two divided by 2 which is represented as nnpfc_num_input_pics_minus2/2, wherein i is an integer number, and/or
wherein only one instance of i-th NNPFC interpolated pictures which is represented as nnpfc_interpolated_pics[i] is indicated in an NNPFC SEI message, and/or
wherein nnpfc_num_input_pics_minus2 is an even number, and the middle pair of input pictures are the nnpfc_num_input_pics_minus2/2-th input picture and the (nnpfc_num_input_pics_minus2/2+1)-th input picture, and/or
wherein one or more syntax elements are indicated to specify the interpolated pictures, and/or
wherein the interpolated pictures are determined based on input pictures.

12. The method of claim 11, wherein the i-th NNPFC interpolated pictures is equal to 0 for all other values of i, and/or
wherein a syntax element which is represented as nnpfc_interpolated_pics_minus1 is indicted in the NNPFC SEI message, and
wherein nnpfc_interpolated_pics_minus1 plus 1 specifies the number of interpolated pictures between the middle pair of input pictures, and/or
wherein a least POC value and a largest POC value of the interpolated pictures are indicated, and/or
wherein a least POC value of the interpolated pictures is indicated, and a largest POC value of the interpolated pictures is derived based on the number of interpolated pictures which is indicated in an NNPFC SEI message, and/or
wherein the interpolated pictures are between the middle pair of input pictures, and/or
wherein the interpolated pictures are between a first pair of input pictures, and/or
wherein the interpolated pictures are between a last pair of input pictures, and/or
wherein pictures are interpolated between a pair of consecutive input pictures and an indentification of the pair is indicated.

13. The method of claim 12, wherein the input pictures with the index of
$$[ \frac{N}{2} ] and [ \frac{N}{2} ] + 1$$
comprises the middle pair of input pictures, wherein N is an integer number and represents the number of input pictures and └x┘ represents a greatest integer less than or equal to x, and/or
wherein POC values of input pictures in the pair are indicated, and/or
wherein an index of a first input picture in the pair is indicated.

14. The method of claim 10, wherein the unavailable pictures are replaced with closest available picture in an order of decoding order, and/or
wherein the unavailable pictures are replaced with available picture with a lowest quantization parameter (QP) in an order of decoding order, and/or
wherein the unavailable pictures are padded with a default value, and/or
wherein a bilinear filter is used for interpolation of the unavailable pictures, and/or
wherein a bicubic filter is used for interpolation of the unavailable pictures, and/or
wherein a Lanczos filter is used for interpolation of the unavailable pictures, and/or
wherein a neural network based interpolation filter is used for interpolation of the unavailable pictures.

15. The method of claim 14, wherein the default value is normalized, and/or
wherein the default value is not normalized and in a range from 0 to N−1, inclusive, where N is an integer.

16. The method of claim 15, wherein the default value is 0, or wherein the default value is 0.5, or wherein the default value is 1, and/or
wherein the N is specified to 1<< (nnpfc_inp_tensor_bitdepth_minus8+8).

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to perform a method, wherein the method comprises:
determining, for a conversion between a video unit of a video and a bitstream of the video, a neural-network post-filter (NNPF) is activated for a set of pictures related to the video unit;
apply the NNPF to one or more pictures in the set of pictures according to an order; and
performing the conversion based on output of the NNPF.

19. A non-transitory computer-readable storage medium storing instructions that cause a processor to perform a method, wherein the method comprises:
determining, for a conversion between a video unit of a video and a bitstream of the video, a neural-network post-filter (NNPF) is activated for a set of pictures related to the video unit;
apply the NNPF to one or more pictures in the set of pictures according to an order; and
performing the conversion based on output of the NNPF.

20. A non-transitory computer-readable recording medium storing a bitstream of a video which is generated by a method performed by an apparatus for video processing, wherein the method comprises:
determining a neural-network post-filter (NNPF) is activated for a set of pictures related to a video unit of the video;
apply the NNPF to one or more pictures in the set of pictures according to an order; and
generating the bitstream based on output of the NNPF.
